(19) United States
(12) Patent Application Publication
(10) Pub. No.: US 2019/0316980 A1
(43) Pub. Date: Oct. 17, 2019

(54) PRESSURE SENSOR DEVICE AND CHAIR SYSTEM HAVING THE SAME

(71) Applicant: Hongik University Industry-Academia Cooperation Foundation, Seoul (KR)

(72) Inventor: Jung Hwan SEO, Seoul (KR)

(21) Appl. No.: 15/953,945

(22) Filed: Apr. 16, 2018

(51) Int. Cl. G01L 9/00; B60N 2/90

(52) U.S. Cl. CPC G01L 9/0082; B60N 2002/981; B60N 2/90

(57) ABSTRACT

A pressure sensor device includes: a first air pack which contains air therein; a pressure sensor which is disposed in the first air pack to measure air pressure inside the first air pack; a second air pack which contains air therein; and a hose connected to the first air pack and the second air pack so as to allow air to communicate therebetween, wherein the air pressure sensor measures an air pressure change inside the first air pack which is generated by a pressure applied to the second air pack, and the pressure sensor device measures the pressure based on the air pressure value measured by the air pressure sensor. A chair system includes the pressure sensor device, and a pressure is measured based on the air pressure value measured by the air pressure sensor of the pressure sensor device.

### BACKGROUND OF THE INVENTION

### 1. Field of the Invention

The present invention relates to a pressure sensor device and a chair system having the same, and more particularly, to a pressure sensor device capable of measuring a pressure of a user in a non-contact manner therewith, and a smart chair system capable of estimating a user's posture using the pressure sensor device.

### 2. Description of the Related Art

As modern people pay more attention to health, the need and demand for right posture is increasing.

In particular, studies have shown that sitting posture may put a heavy strain on joints and muscles of a human body, and thus the need for means and design for assisting in taking a right sitting posture is increasing.

A so-called “smart posture control system” have been studied in various ways, which assists a user in taking a right sitting posture by collecting a pressure distribution applied to a seat of a chair for a user who has to sit in the chair for a long time, such as a vehicle driver or a student.

According to the conventional methods, to measure the pressure distribution according to the posture of the user, a sensor means such as a piezoelectric sensor and a force sensing resistor (FRS) sensor is generally used, which is configured to measure a pressure of the user by a shape deformation due to direct contact therewith.

When using the contact-type sensor such as the FSR sensor for a long time, what is called a “drift phenomenon” may occur, which leads to a deterioration in an accuracy of the sensor. This means that the contact-type sensor has a relatively low durability, and thus is likely to have a short maintenance period as well as need to be repaired within a short time.

Further, since it is necessary to directly embed the sensor in the seat to which the pressure is directly applied by the user, a lot of cost and effort on maintenance are required when the sensor is to be replaced due to poor accessibility. For example, the user would have to detach the entire seat to replace the sensor.

Furthermore, a price of the sensor itself is high, and as a result, there is a limitation in popularizing a posture sensing system through the pressure distribution.

### SUMMARY OF THE INVENTION

In consideration of the above-mentioned circumstances, it is an object of the present invention to provide a pressure sensor device having excellent durability with a simple structure in installation and maintenance, and a smart chair system capable of estimating posture information of a user using the pressure sensor device.

In order to achieve the above-described object, according to an aspect of the present invention, there is provided a pressure sensor device including: a first air pack which contains air therein; and a pressure sensor which is disposed in the first air pack to measure air pressure inside the first air pack.

According to one embodiment, the pressure sensor device further includes: a second air pack which contains air therein; and a hose connected to the first air pack and the second air pack so as to allow air to communicate therebetween, wherein the air pressure sensor measures an air pressure change inside the first air pack which is generated by a pressure applied to the second air pack, and the pressure sensor device measures the pressure based on the air pressure value measured by the air pressure sensor.

According to one embodiment, the first air pack is detachably connected to the hose.

According to one embodiment, the first air pack includes an air inlet to inject air into the first air pack.

According to one embodiment, the hose is made of a flexible material.

According to another aspect of the present invention, there is provided a chair system including: a seat on which a user sits; and the pressure sensor device of the above aspect, wherein the first air pack is embedded in the seat at a position in which a weight of a user is applied to be pressed, and the air pressure sensor of the pressure sensor device measures an air pressure change inside the first air pack which is generated when the first air pack is pressed by the pressure applied by the weight of the user sitting on the seat, and the pressure sensor device measures the pressure based on the air pressure value measured by the air pressure sensor.

According to one embodiment, the chair system includes a plurality of pressure sensor devices, wherein a pressure distribution measured by each pressure sensor device is calculated.

According to one embodiment, the first air pack is installed in the seat at a position against which a weight of a user is not pressed, the second air pack is embedded in the seat at a position against which the weight of the user is pressed, and the air pressure sensor of the pressure sensor device measures an air pressure change inside the first air pack which is generated when the second air pack is pressed by a pressure applied by the weight of the user sitting on the seat, and the pressure sensor device measures the pressure based on the air pressure value measured by the air pressure sensor.

According to one embodiment, the first air pack is detachably connected to the hose, and the first air pack is installed so as to be exposed to the outside of the seat through a maintenance hole which is opened to the outside of the seat.

According to one embodiment, a posture of the user is estimated by the pressure distribution measured by the respective pressure sensor devices.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a configuration of a pressure sensor device according to an embodiment of the present invention;

FIG. 2 is a view showing a configuration of a smart chair system according to an embodiment of the present invention to which the pressure sensor device of FIG. 1 is applied;

FIG. 3 is a view showing a seat of the smart chair system in which a plurality of pressure sensor devices are installed;

FIG. 4 is a front view showing a user seated on a seat of the smart chair system;

FIG. 5 is a graph illustrating a pressure distribution measured according to the posture of FIG. 4;

FIG. 6 is a side view showing the user seated on the seat of the smart chair system;

FIG. 7 is a graph illustrating a relative pressure distribution measured according to the posture of FIG. 6;

FIG. 8 is a graph illustrating pressure measurement values in each sensor acquired in real time; and

FIG. 9 is a graph visualizing a center-of-gravity position of a user displayed in two dimensions.

### DETAILED DESCRIPTION OF THE INVENTION

Hereinafter, preferred embodiments of the present invention will be described in detail with reference to the accompanying drawings. In this regard, the present invention will be described based on the embodiments illustrated in the drawings, but these embodiments will be described as an example, and it should be understood the technical idea, core configurations and actions of the present invention are not limited thereto.

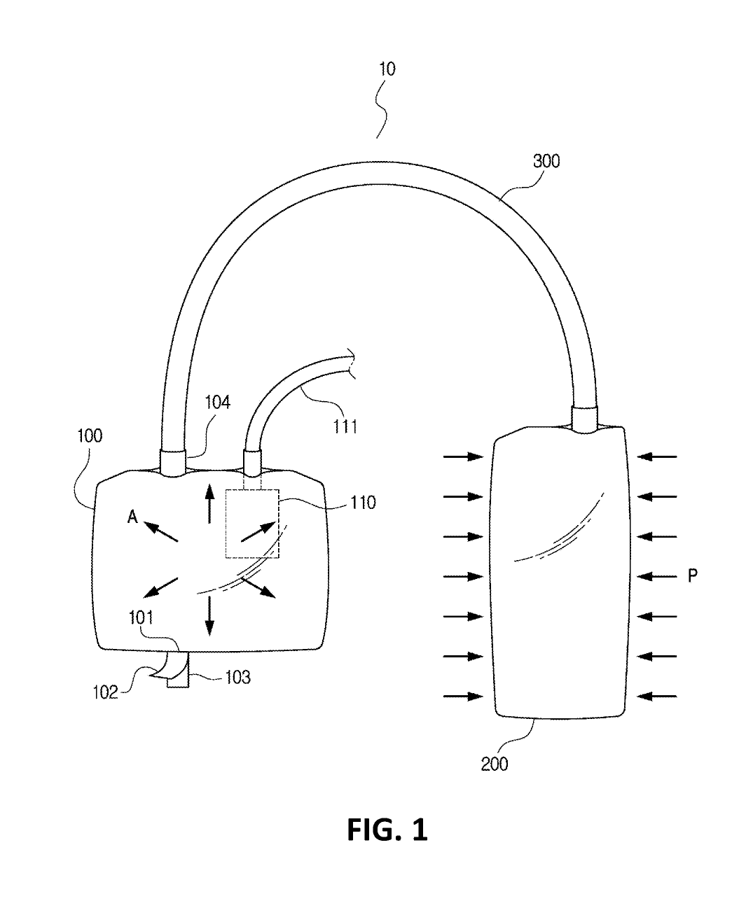

FIG. 1 is a view showing a configuration of a pressure sensor device 10 according to one embodiment of the present invention.

The pressure sensor device 10 according to the present embodiment includes a first air pack 100 and a second air pack 200 that contain air therein, and a hose 300 of which both ends are connected to the first air pack 100 and the second air pack 200, respectively, thereby allowing air to communicate therebetween.

In the first air pack 100, an air pressure sensor 110 capable of measuring a pressure change inside the first air pack 100 is disposed. An example of the air pressure sensor 110 includes a “BMP 180 barometric pressure sensor” from Bosch, Germany. The BMP 180 barometric pressure sensor is an air pressure sensor that can operate even at a low voltage while having a chip shape smaller than a coin.

The air pressure sensor 110 is connected with a wire 111 extending to an outside of the first air pack 100. The air pressure sensor 110 can receive power from the outside and transmit data on air pressure values measured therein through the wire 111. A portion of the first air pack 100 through which the wire 111 passes is sealed so as to prevent the air from leaking out to the outside.

The first air pack 100 according to the present embodiment is connected to the hose 300 through a connecting part 104. The connecting part 104 is detachably coupled with the hose 300, such that the first air pack 100 may be detached from the hose 300 as necessary.

According to the present embodiment, the first air pack 100 and the air pressure sensor 110 disposed therein may be formed in one module. In this case, when the air pressure sensor 110 is defective or fails in an operation, the first air pack 100, in which the air pressure sensor 110 is accommodated, is detached from the hose 300 and replaced by a new module, thereby achieving a simple structure in maintenance.

Referring to FIG. 1, the first air pack 100 has an air inlet 101 which is formed therein for allowing air to be injected into the first air pack 100.

When the first air pack 100 is detached from the hose 300, air inside the second air pack 200 leaks out through the hose 300. However, when a new first air pack 100 is connected thereto and a predetermined amount of air is injected through the air inlet 101, the first air pack 100 and the second air pack 200 may be filled with air.

According to the present embodiment, a check valve including two overlapping films 102 and 103 is provided in the air inlet 101. The two films 102 and 103 are adhered to each other when an air injector (not shown) is removed from the air inlet 101 to prevent the air from leaking out from the first air pack 100. According to the present embodiment, although the check valve including the two overlapping films 102 and 103 is illustrated, the present invention is not limited thereto, and various check valves for allowing air to flow into the first air pack 100 but preventing the air from leaking out therefrom may be used.

As shown in FIG. 1, when the second air pack 200 is pressed by a pressure P applied thereto from the outside of the second air pack 200, the pressure inside the second air pack 200 is increased, which, in turn, changes the air pressure A inside the first air pack 100. According to the present embodiment, a change in the air pressure A inside the first air pack 100 is measured by the air pressure sensor 110, and the measured air pressure value is provided as information for measuring a magnitude of the pressure P applied to the second air pack 200.

The pressure P of which the magnitude is known in advance by measurement is applied to the second air pack 200, and the air pressure A of the first air pack 100 is measured by the air pressure sensor 110 at the pressure P, such that a relationship between the applied pressure value and the measured air pressure value can be derived, and the derived relationship can be calibrated against the pressure by the air pressure sensor 110.

When measuring the air pressure inside the first air pack 100 by the calibrated air pressure sensor 110, it is possible to measure the pressure P applied to the second air pack 200.

In the pressure sensor device 10 according to the present embodiment, the pressure is measured in such a way that the air pressure sensor 110 measures a pressure which is indirectly transmitted through the air without coming into any direct contact with the air pressure sensor or applying an external force thereto. Therefore, the pressure sensor device may have a very higher durability than the contact-type pressure sensor device.

Meanwhile, the pressure sensor device 10 according to the present embodiment includes the first air pack 100 that is provided with the air pressure sensor 110, the second air pack 200, and the hose 300, but it is not particularly limited thereto.

Alternately, the pressure sensor device may be formed in a simple configuration by including the first air pack 100 sealed with air being contained and the air pressure sensor 110 disposed in the first air pack 100. When pressing the first air pack 100 itself to apply a pressure thereto, a change in the air pressure inside the first air pack 100 occurs. The air pressure sensor 110 may be configured to measure the pressure change inside the first air pack 100 which occurs when the first air pack 100 is pressed, and also measure the pressure value of pressing the first air pack 100 based on the measured pressure change value.

However, as will be described below, when using the pressure sensor device 10 according to the present embodiment, which includes the first air pack 100 provided with the air pressure sensor 110, the second air pack 200, and the hose 300, it is possible to maximize convenience in maintenance and replacement when applying the pressure sensor device 10 to a chair system or the like.

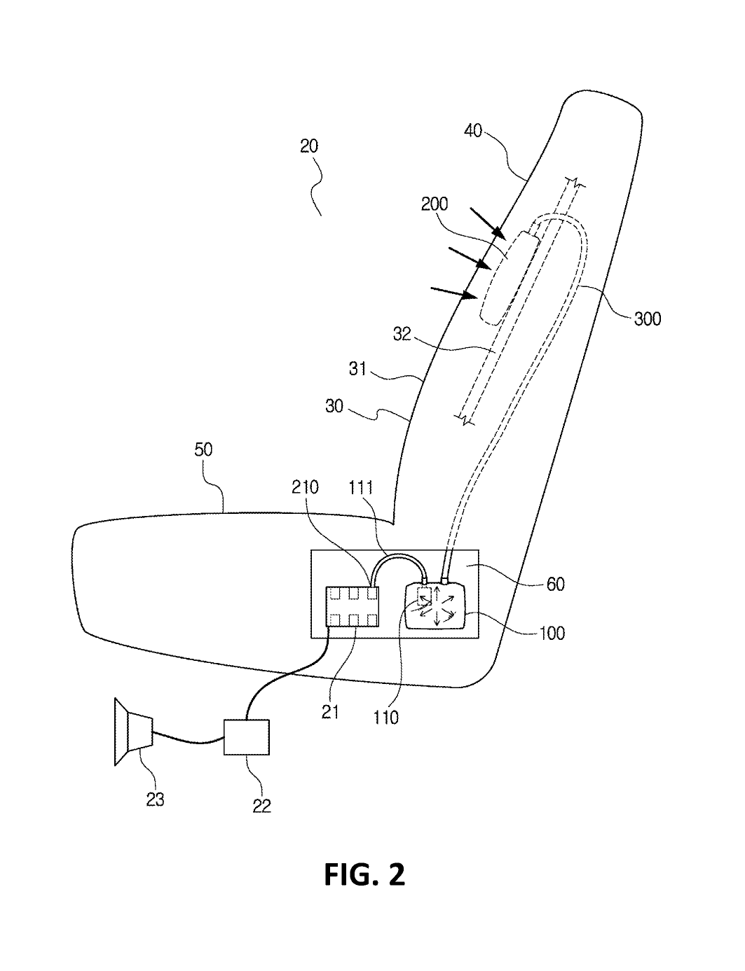

FIG. 2 is a view showing a configuration of a smart chair system 20 according to an embodiment of the present invention, to which the pressure sensor device 10 is applied. The chair system 20 according to the present embodiment is a chair system intended to be applied to a vehicle.

Referring to FIG. 2, the chair system 20 includes a seat 30 on which a user sits, and the pressure sensor device 10 that is formed in the seat 30.

The seat 30 includes a frame 32 (not shown in detail in FIG. 2) for maintaining a shape of the seat and a cushion 31 for covering the frame 32. The seat 30 is largely divided into two parts; one is a seat back 40 for supporting the user's back, and the other is a seat plate 50 for supporting the user's hips.

As shown in FIG. 2, the second air pack 200 of the pressure sensor device 10 is embedded inside the seat 30. The second air pack 200 is disposed inside or under the cushion of the seat back 40, and is installed at a position in which the second air pack 200 can be pressed by a weight of the user when the user sits on the seat 30. The frame 32 of the seat 30 supports a back side of the second air pack 200 so as to prevent the second air pack 200 from retreating backward, thereby allowing the pressure applied by the user to be transmitted to the second air pack 200.

According to the present embodiment, the position in which a load is concentrated on the back of the user was calculated using a segmentation method of simplifying a human body into a plurality of segments. When the second air pack 200 is positioned in the seat back 40, a position which is apart from the lowest portion of a cushion of the seat back 40 in a height of about 25 to 30 cm was determined as a position suitable for positioning the second air pack 200. However, the above-described position is merely exemplary, and a suitable position may be determined depending on a material, a type, and the like of the seat.

Referring to FIG. 2, the hose 300 of the pressure sensor device 10 extends to the inside of the seat 30. According to the present embodiment, the hose 300 is made of a flexible material, and may be formed in various lengths as necessary.

Therefore, since the hose 300 may be freely bent and extended, it is possible to easily install the pressure sensor device 10 even in a versatile seat in which there is not sufficient free space, such as a vehicle seat having a lot of components such as a motor, wires, or the like installed therein.

According to the present embodiment, the sitting plate 50 of the seat 30 has a maintenance hole 60 formed on a side thereof to be opened to the outside of the seat 30, and the hose 300 extends to the maintenance hole 60.

The first air pack 100 of the pressure sensor device 10 is disposed at a position, in which the maintenance hole 60 is formed, with being connected to the hose 300, so as to be exposed to the outside of the seat 30 through the maintenance hole 60. Therefore, the first air pack 100 is installed in the seat 30 at a position in which the seat 30 is not pressed by the weight of the user, and is disposed at a position easily accessible from the outside.

According to an embodiment, since the first air pack 100 is detachably connected to the hose 300, when there is a problem with the air pressure sensor 110 inside the first air pack 100, the first air pack 100 is detached and is replaced by a new one through the maintenance hole 60, thus to easily solve the above-described problem.

In this process, since it is not necessary for the hose 300 and the second air pack 200 embedded in the seat 30 to be separated from the seat 30, it is possible to greatly reduce the effort and cost required to maintain and repair the pressure sensor device 10. In addition, the second air pack 200 can be semi-permanently used unless it is damaged by a sharp object or the like, such that it is possible for the pressure sensor device 10 to have a very high durability and a very long lifespan.

Referring to FIG. 2, the wire 111 connected with the air pressure sensor 110 is connected to one terminal of a multiplexer 21 provided at the position in which the maintenance hole 60 is formed to be connected to a computer 22.

When the user sits on the seat 30, the second air pack 200 is pressed by the pressure applied by the weight of the user, and the resulting air pressure change inside the first air pack 100 is measured by the air pressure sensor 110. The computer 22 calculates the pressure applied to the second air pack 200 based on the air pressure value measured by the air pressure sensor 110.

Although one pressure sensor device 10 installed in the seat 30 is shown in FIG. 2, in the chair system 20 according to the present embodiment, a plurality of pressure sensor device 10 may be installed in the seat 30, and the pressure distribution measured by respective pressure sensor devices 10 may be calculated.

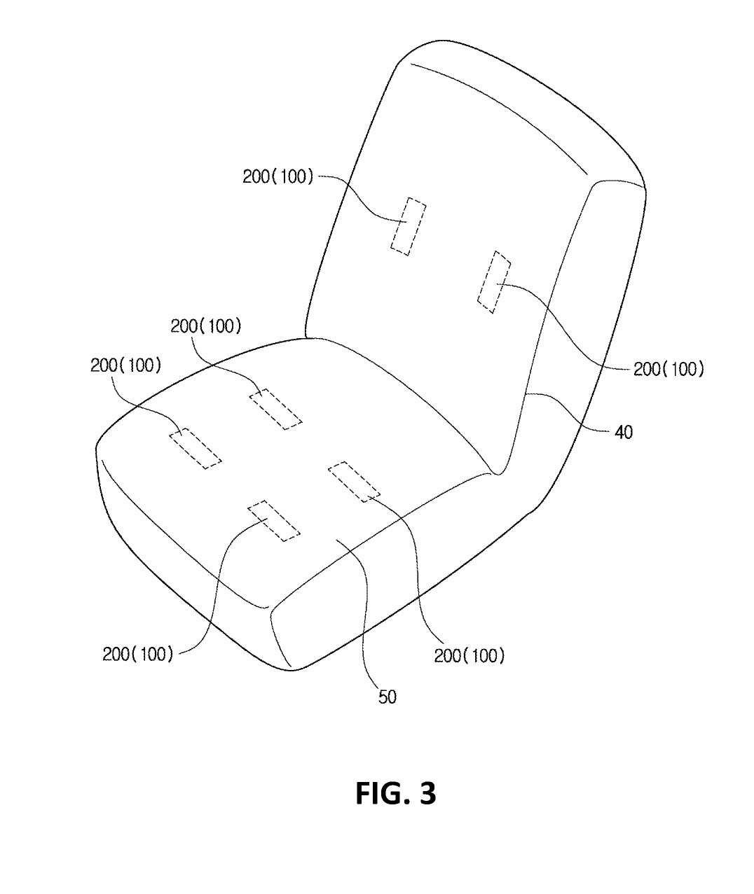

FIG. 3 is a view showing a seat 30 of the smart chair system in which a plurality of pressure sensor devices 10 are installed.

As shown in FIG. 3, according to the present embodiment, a total of six pressure sensor devices 10 are installed in the seat 30, and among the second air packs 200 of the pressure sensor devices, two are embedded in the seat back 40, and four are embedded in the sitting plate 50.

Although not shown in detail, all the hoses 300 of the respective pressure sensor devices 10 are extended to the position in which the maintenance hole 60 is formed, and six first air packs 100 are appropriately fixed at the position of the maintenance hole 60.

The wire 111 extending from each first air pack 100 is connected to each terminal of the multiplexer 21 to be connected to the computer 22.

The six first air packs 110 are paired by two, and the paired first air packs 110 are symmetrically disposed with respect to a plane dividing the seat 30 vertically into halves.

The first air packs 110 disposed in the sitting plate 50 are disposed in two rows at positions that are located about 13 cm and 30 cm from the knee of the user (that is, the front end of the sitting plate 50), respectively.

In the present embodiment, the second air packs 200 are disposed at positions shown in FIG. 3. However, as described above, when the pressure sensor device has a simple configuration, that is, includes only the first air pack 110 and the air pressure sensor 110, those skilled in the art will understand that the first air pack 110 may be disposed at the corresponding positions (indicated in parentheses in FIG. 3). In this case, the air pressure sensor 110 measures the air pressure change inside the first air pack 100, which is generated when the first air pack 110 is pressed by a pressure applied by the user sitting on the seat 30. Further, based on the pressure value measured by the air pressure sensor 110, the pressure applied to the first air pack 110 can be measured.

Meanwhile, according to the present embodiment, the distribution of the pressure applied to the seat 30 by the user can be calculated through the pressure value measured by each of the six pressure sensor devices 10 that are uniformly disposed in the seat 30. The computer 22 can estimate the user's posture forming the pressure distribution calculated using pre-built database.

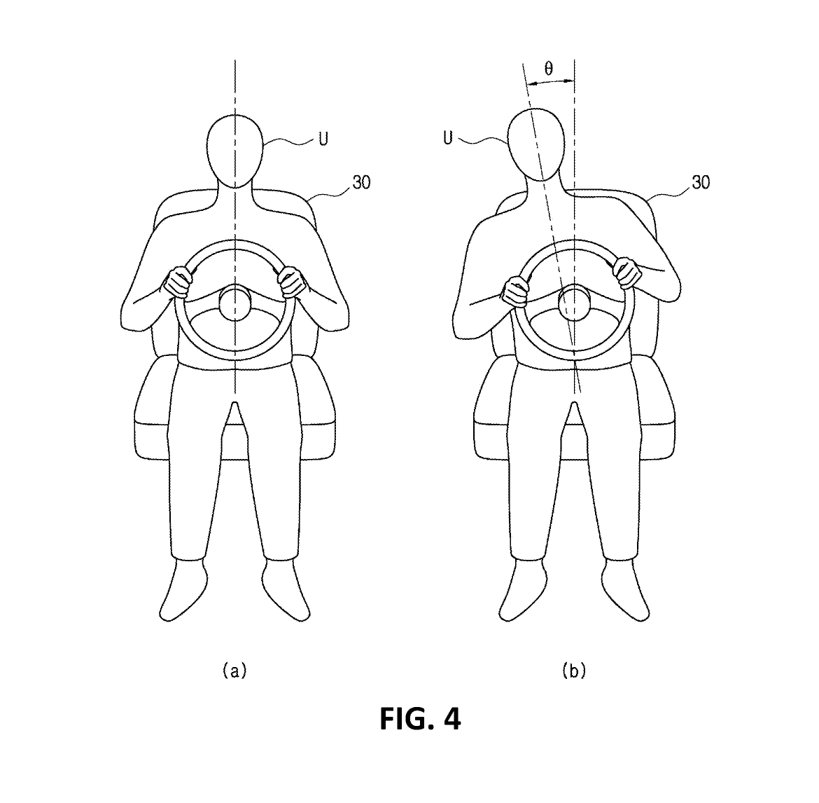

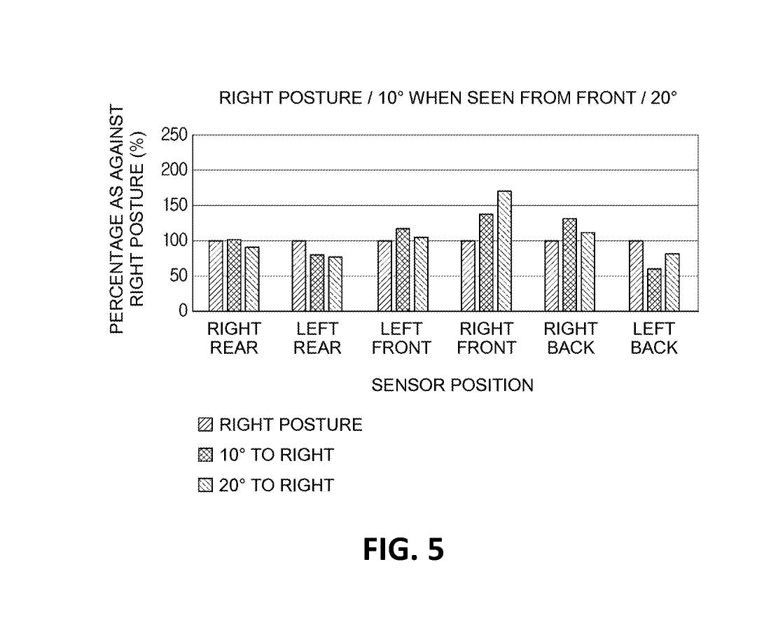

FIG. 4 is a front view showing a user U seated on the seat 30, and FIG. 5 is a graph illustrating a relative pressure distribution of the pressure values measured by six pressure sensor devices 10 according to the posture of FIG. 4.

FIG. 4(a) shows a right posture in which the user U is seated correctly, and FIG. 4(b) shows a posture in which the user U is seated in a state of being tilted by θ° when seen from the front.

As shown in FIG. 5, it can be seen that the pressure distribution is changed when the user U is seated in states of being tilted to the right by 10° and 20° when seen from the front, respectively, as against the pressure distribution of the user U being seated in the right posture (FIG. 4(a)).

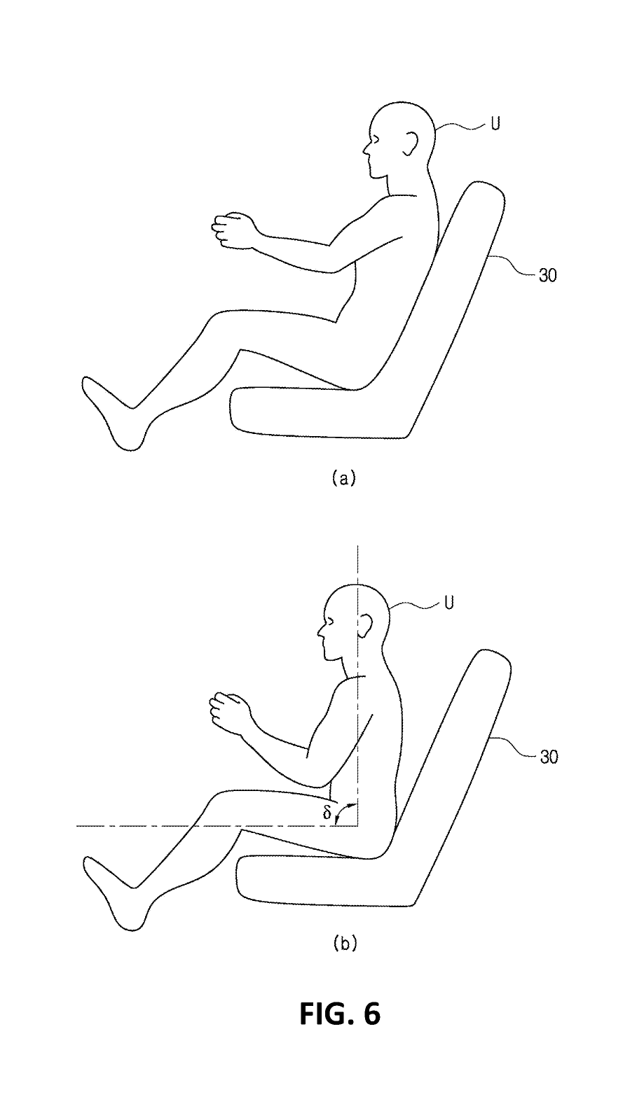

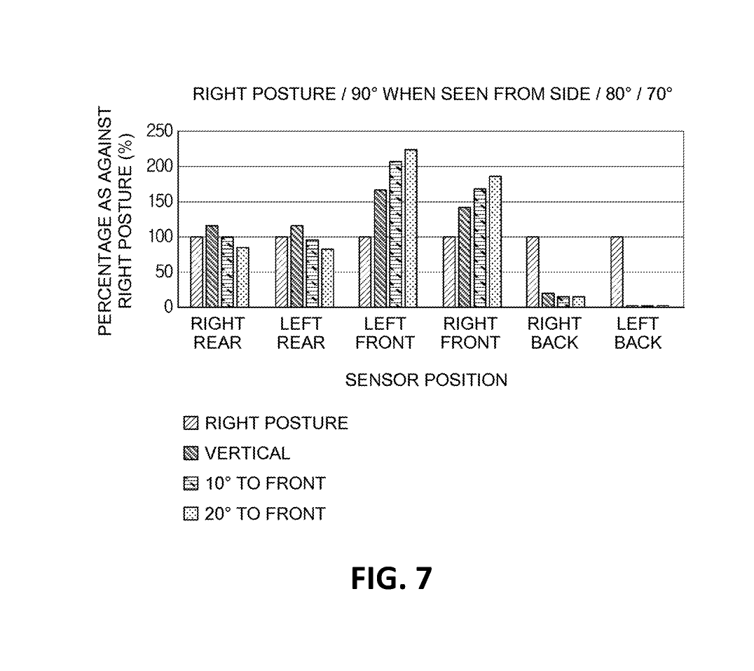

Similarly, FIG. 6 is a side view showing the user U seated on the seat 30 of the smart chair system, and FIG. 7 is a graph illustrating a relative pressure distribution of the pressure values measured by six pressure sensor devices 10 according to the posture of FIG. 6.

FIG. 6(a) shows a right posture in which the user U is seated correctly, and FIG. 6(b) shows a posture in which the user U is seated in a state of being tilted by δ° when seen from the side.

As shown in FIG. 7, it can be seen that the pressure distribution is changed when the user U is seated in states of being tilted to the right by 90°, 80° and 70° when seen from the side respectively, as against the pressure distribution of the user U being seated in the right posture (FIG. 6(a)).

As described above, the pressure distribution which seen through the pressure values measured by 6 pressure sensor devices 10 according to the sitting posture of the user exhibits a certain pattern. Therefore, by analyzing the pattern of the pressure distribution, it is possible to estimate the posture in which the user U is now taking.

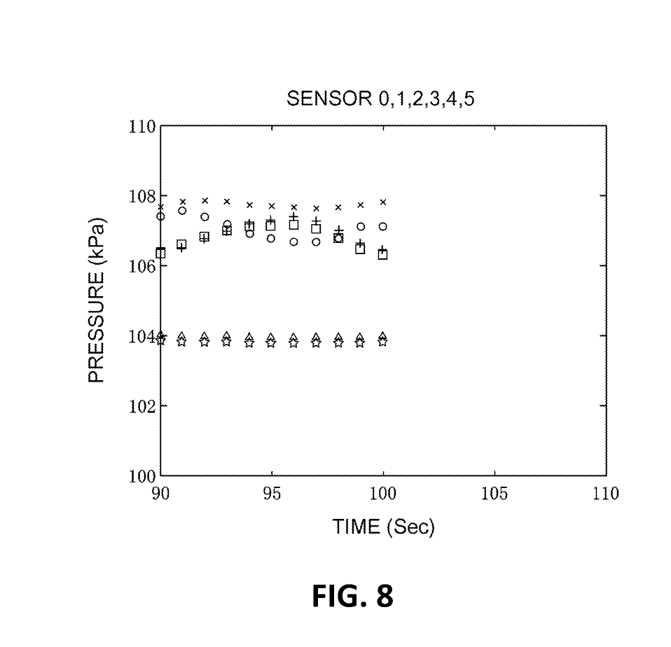

Furthermore, since six pressure sensor devices 10 can collect data in real time, the pressure distribution of the seat 30 according to the user's posture can be converted into data in real time. FIG. 8 is a graph illustrating pressure measurement values in each sensor acquired in real time.

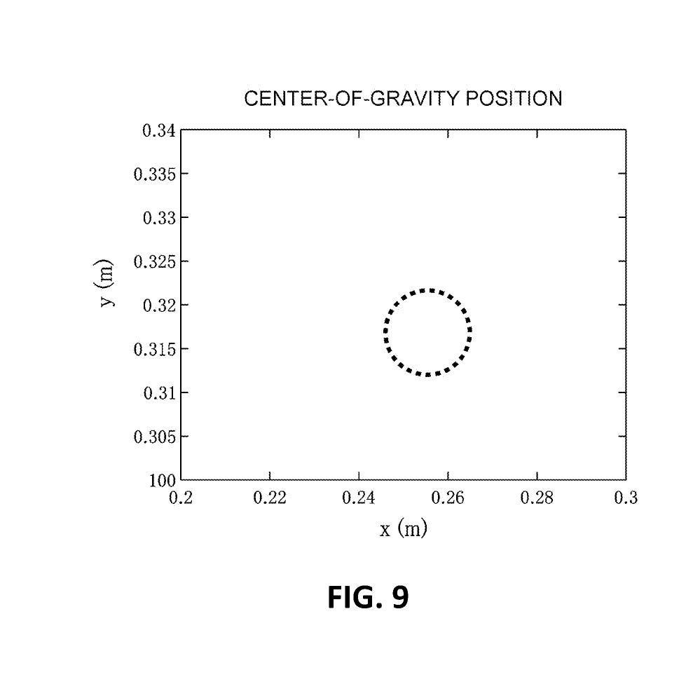

By using the pressure distribution data acquired as described above and body information of the user such as a height, a weight, and the like, the center-of-gravity position of the user according to the posture change of the user can be calculated. FIG. 9 is a graph visualizing the center-of-gravity position of the user displayed in two dimensions through MATLAB.

Since the user's posture is detected in real time by checking the pressure distribution according to the change of posture of the user, when the user is taking a posture deviating from the right posture for more than a predetermined time, the computer 22 may warn to the user through an interface means such as a speaker 23, so that the user should take a right posture (see FIG. 2).

Furthermore, the posture information of the user may be used for smart driving or unmanned driving technique of the vehicle, such as controlling the behavior of a vehicle, for example acceleration and deceleration of the vehicle, controlling air bag deployment, and so on, by determining whether or not the user's weight is shifted.

According to the present embodiment, since each pressure sensor device is separately built as a module, it is possible to selectively replace only the air pressure sensor in which breakage or failure has occurred.

After the first air pack 100 of one pressure sensor device is removed and a new first air pack is substituted, the driver or a mechanic can sit on the seat 30 in a right posture, and then simply perform calibration between a plurality of pressure sensor devices by controlling the air pressure sensor so that the detected values from the substituted pressure sensor device matches the pressure distribution pattern that appears at the time of the right posture.

According to the present embodiment, the chair system applied to the vehicle has been described by way of example, but the present invention is not limited thereto. Those skilled in the art will understand that the spirit of the present invention could be applied to a smart posture control system that is applied to various types of chairs such as a chair for everyday use to assist in taking a right posture.

1. A pressure sensor device comprising:
a first air pack which contains air therein;
an air pressure sensor which is disposed in the first air pack to measure air pressure inside the first air pack;
a second air pack which contains air therein; and
a hose connected to the first air pack and the second air pack so as to allow air to communicate therebetween,
wherein the air pressure sensor measures an air pressure change inside the first air pack which is generated by a pressure applied to the second air pack, and the pressure sensor device measures the pressure in real time based on the air pressure value measured by the air pressure sensor.

2. The pressure sensor device according to claim 1, wherein the first air pack is detachably connected to the hose.

3. The pressure sensor device according to claim 2, wherein the first air pack comprises an air inlet to inject air into the first air pack.

4. The pressure sensor device according to claim 1, wherein the hose is made of a flexible material.

5. A chair system comprising:
a seat on which a user sits; and
the pressure sensor device according to claim 1,
wherein the first air pack is installed in the seat at a position against which a weight of a user is not pressed,
the second air pack is embedded in the seat at a position against which the weight of the user is pressed, and
the air pressure sensor of the pressure sensor device measures an air pressure change inside the first air pack which is generated when the second air pack is pressed by a pressure applied by the weight of the user sitting on the seat, and the pressure sensor device measures the pressure based on the air pressure value measured by the air pressure sensor.

6. The chair system according to claim 5,
wherein the first air pack is detachably connected to the hose, and
the first air pack is installed so as to be exposed to the outside of the seat through a maintenance hole which is opened to the outside of the seat.

7. The chair system according to claim 5,
comprising a plurality of pressure sensor devices,
wherein a pressure distribution measured by the respective pressure sensor devices is calculated.

8. The chair system according to claim 7, wherein a posture of the user is estimated by the pressure distribution measured by the respective pressure sensor devices.
